(19) United States
(12) Patent Application Publication
(10) Pub. No.: US 2001/0032200 A1
(43) Pub. Date: Oct. 18, 2001

(54) Method and apparatus for providing continuously updated information about an item

(76) Inventor: Lourence Cornelius Johannes Greyvenstein, Johannesburg (ZA)

Correspondence Address: D. Peter Hochberg Co., L.P.A., 6th Floor, 1940 East 6th Street, Cleveland, OH, 44114-2294, US

(21) Appl. No.: 09/794,170

(22) Filed: Feb. 26, 2001

(30) Foreign Application Priority Data
Feb. 25, 2000 (ZA) 2000/0856
Aug. 10, 2000 (ZA) 2000/4065

(51) Int. Cl. G06F 17/30

(52) U.S. Cl. 707/3; 707/104.1

(57) ABSTRACT

The invention describes a method and apparatus for enabling a patentee to obtain outside input as to the viability of the invention which has been patented. The method involves making certain fixed information such as details of the patent, (the patent specification and drawings etc) available to enquirers and, when supplying such fixed information to submit a questionnaire to the enquirer so that the enquirer can provide an assessment of the viability of the invention. The enquirer will give details of his demographics. The apparatus can process the results of the questionnaires giving results and details of the characteristics of the persons who provided any specific form of information.

This invention relates to a system for and method of supplying information relating to items. It involves a process for integrated management of feedback as transacted on a plurality of interconnected computers.

Networking of computers has become the standard means of importing a large quantity of data from several machines and permitting one or several machines to process the information. The benefits of networking is to allow an end user to be able to obtain the capture data from several computers, and have all the capture data processed the form that allows the end user to draw conclusions readily and accurately based on all the data that has been captured. The information made available to the end user is often processed using standard statistical means and is often displayed in graph form.

A recent phenomenon is the information available to the public has been the Internet. The Internet is made up of smaller link networks or providing public access to a wealth of information, stored at individual sites managed by numerous participants on the Internet. The Internet has already changed, in a dramatic fashion, and many other ways people communicate, collecting and sharing information.

The present invention is concerned with a system for and method of supplying information relating to items to various groups of persons such a persons with an interest in the items, such a person being hereinafter called “a proprietor”), persons who are interested in the items (such a person being hereinafter called “an enquirer” and persons who have privileged access to the items (such a person being hereinafter called “a subscriber”). The information about the items is preferably contained in data strings. These data strings are preferably contain information which is fairly permanent but can from time to time be altered as desired at the main computer system (hereinafter called “fixed data strings”) and alterable information (hereinafter called “alterable data strings”). The system will normally have an individual who operates the system and who when so operating the systems is hereinafter called “the operator”.

According to one aspect of the invention there is provided apparatus for providing continuously updated information about an item, the apparatus comprising:

a main computer system including a software system having a data base which contains various information units, being alterable and substantially fixed information units;

first means for accessing selected said information units about a selected item and making said information units available to the second computer operated by an enquirer connecting to the main computer system;

second means for dispatching a questionnaire to the enquirer at said second computer when it is connected to the main computer system to obtain the said selected fixed information units;

receiving means for receiving information received from a complete questionnaire returned by the said second computer and for adding such information to the main data base thereby to alter certain alterable information units; and

means for accessing the alterable information units relating to an item and making this available to a third computer connecting to the main connector system;

the main computer system preferably further including means operable by the operator to change any of fixed data.

According to another aspect of the invention there is provided a method of providing information to an enquirer requiring said information about an item, the method comprising:

maintaining a data base in a main computer system, which data base comprises fixed and alterable data strings about a number of items,

making selected fixed data strings available to a second computer operated by the enquirer via a computer link and at the same time sending a questionnaire to the enquirer said party at the second computer;

receiving at the main computer system information resulting from completion of the questionnaire and dispatch thereof by the second computer, and

updating the alterable data strings of the said item on the basis of the said the information.

According to a further aspect of the invention there is provided a method of providing information about an item to the proprietor having an interest in the latter item, the method comprising

maintaining a data base in a main computer system, which data base comprises fixed and alterable data strings about a number of items including the said item;

making selected fixed information available to a computer operated by an enquirer via a computer link:

and at the same time in the sending of a questionnaire to the enquirer via said second computer:

receiving at the main computer system information relating resulting from completion of the questionnaire and dispatch thereof by the enquirer through the enquirer's computer:

updating the altered data strings in the main computer system on the basis of the said information resulting from the questionnaire; and

making the information available for access by the proprietor, which said information includes the updated alterable data strings.

The system is preferably arranged to process the completed questionnaire in real-time and automatically to generate a report document providing graphs, statistical information and/or explanatory notes. This will automatically generate an updated report document which is time specific. Report documents of a number of different layouts are preferably generated. These may comprise a large amount of information or a very specific and detailed information as may be required by the subscriber or the proprietor.

The items are conveniently patents.

The standard guest access will allow an enquirer to view the various Patents by category (international patent classification or other suitable classification), by key word search, or by patent number search and/or by other criteria. In this way an enquirer may be able to find inventions in the field in which he is interested or in which he operates. On selecting the field and entering the search option provided all the relevant electronic documents housed in the data base will be displaced giving the user sufficient information for him to select those documents to be displayed in their entirety on the screen of the enquirer's computer. After the enquirer has been able to review the selected documents, the system will prompt the enquirer to complete and submit the questionnaire

The fixed information strings preferably comprise copies of the specification, drawings, and an abridgement of the specification together with of the relevant information about the patents e.g. the number, title, date of issue and country of issue of the patent, the name and address of the patentee, the name and address of the inventor, the priority dates of the patents etc. The alterable data strings may comprise the number of occasions the fixed data string in relation to a patent has been accessed; details of the party accessing the information; and comments of the enquirer as to the practicality, viability or interest in the patent.

The details of the enquirer may conveniently comprise one or more of the following:—the age group within which the second party falls; the geographical location of the second person, the highest level of education of the second party, the years of experience in the market sector applicable to the patents etc.

The information required by the proprietor may also be provided to any other party such as an enquirer or a subscriber although conveniently this is not so. Indeed the subscriber may have access to alterable data strings which are not available to the proprietor and without the knowledge of the proprietor.

The software may comprise a blocking device to refuse information to a second party who does not complete the questionnaire. In addition the software may comprise a further blocking device to refuse information regarding the results of the questionnaires until such time as the proprietor is prepared to release such information. The accessing arrangement for the second party will allow the second party to view various Letters Patent by category, (i.e. international patent classification or by other suitable classification), by keyword search, by patent number search, by search of the names of the proprietors of the patents and the names of the inventor's and/or by other criteria. In this way a user may be able to find inventions in the field in which he is interested or in which he operates.

As mentioned above the system may provide a series of selected report displays which any party may select. Thus for example the report may have in addition to writing report, various graphical displays which may be in the form of bar graphs, pie charts and line graphs.

The arrangement is preferably such that the various items of information can be obtained by one of more parties in real time.

Arrangements of the invention will now be described by way of example. Refernce is made to the drawings which show various block diagrams and similar representations that will assist in the understanding of these arrangements.

In the drawings:

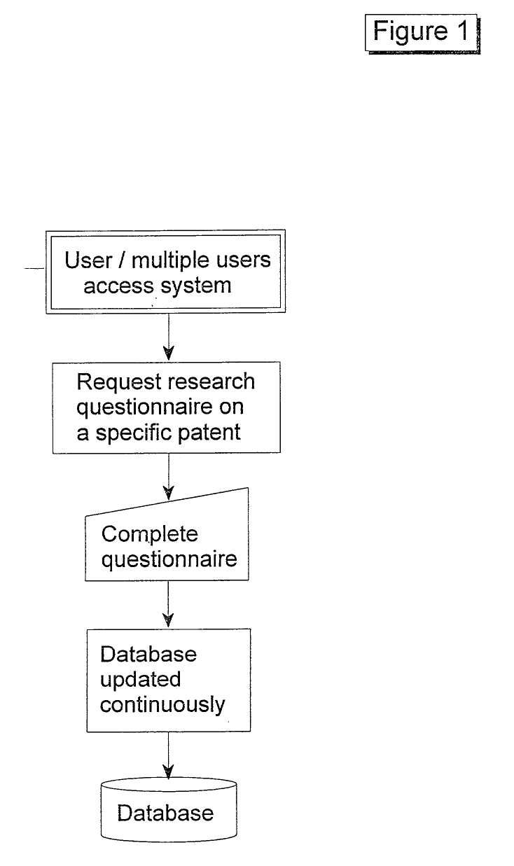

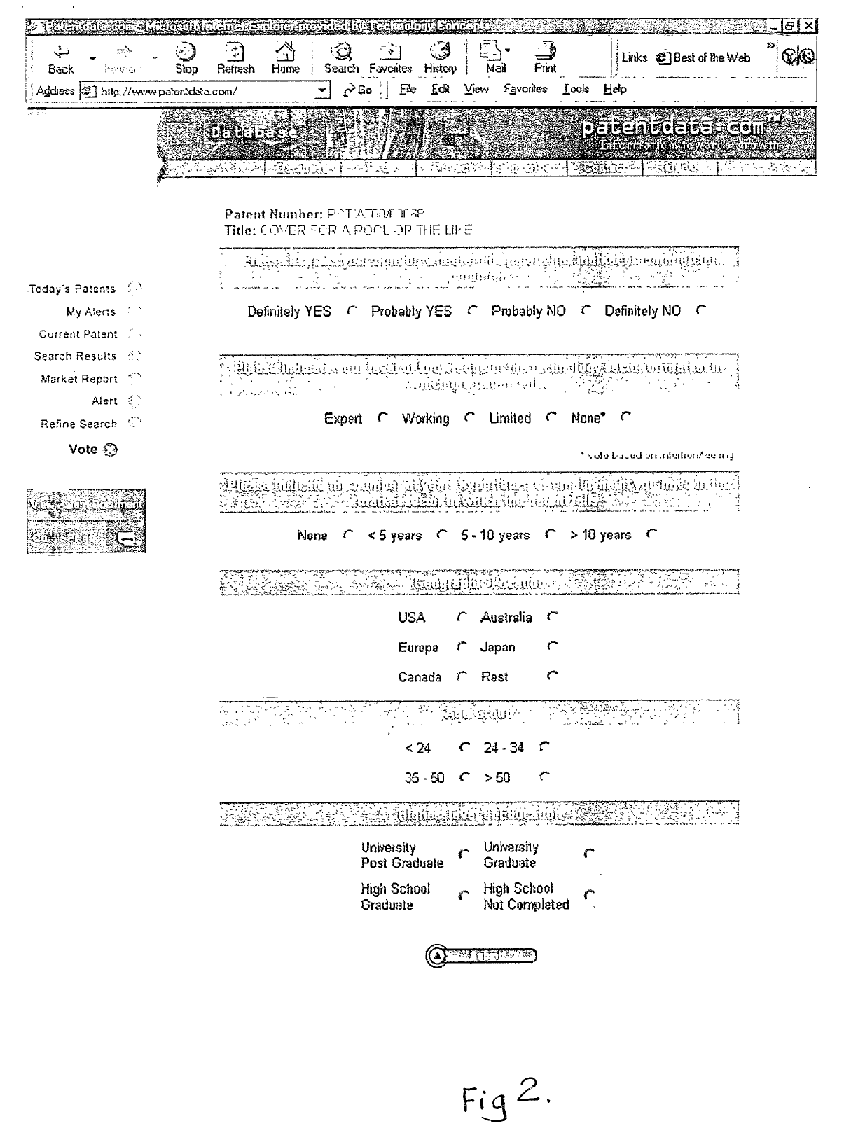

FIG. 1 is a block diagram showing how the arrangement operates;

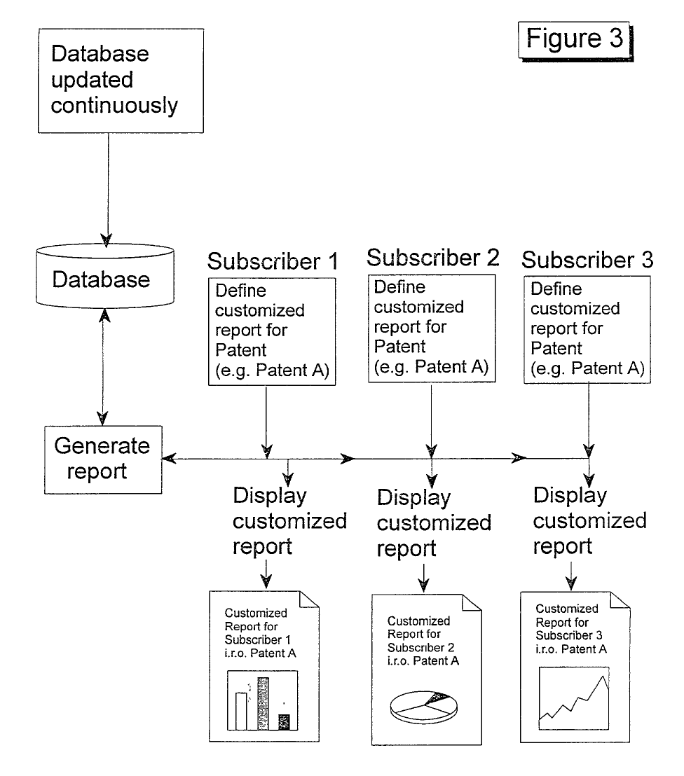

FIG. 2 illustrates a typical questionnaire;

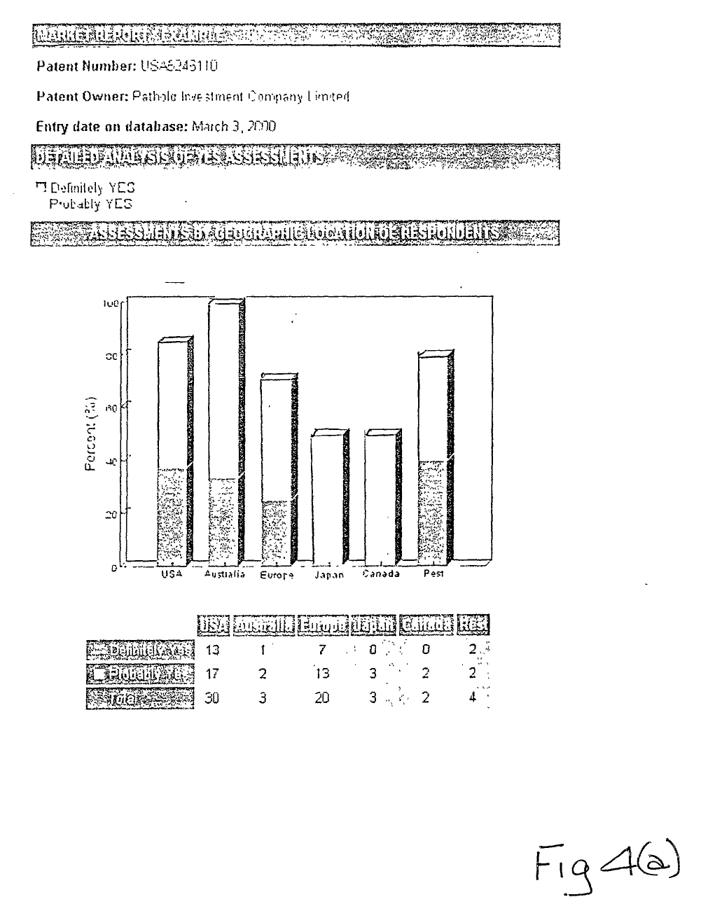

FIG. 3 is a block diagram showing how different reports are generated, and

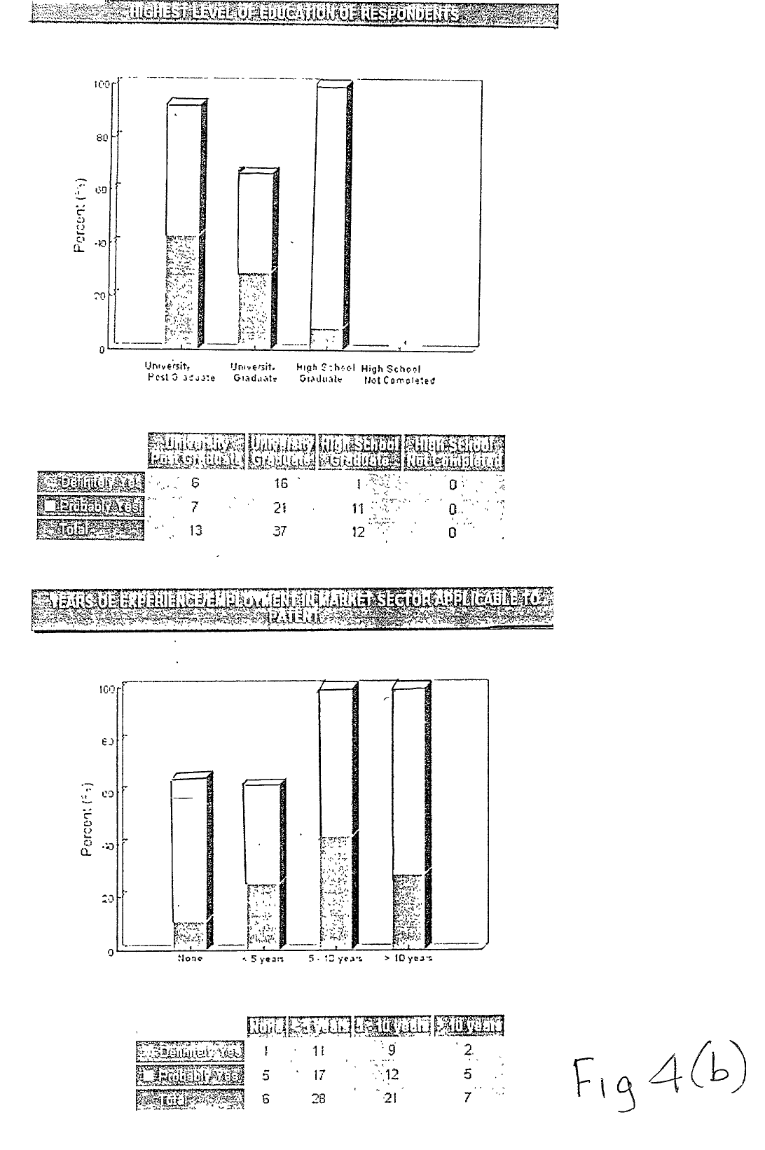

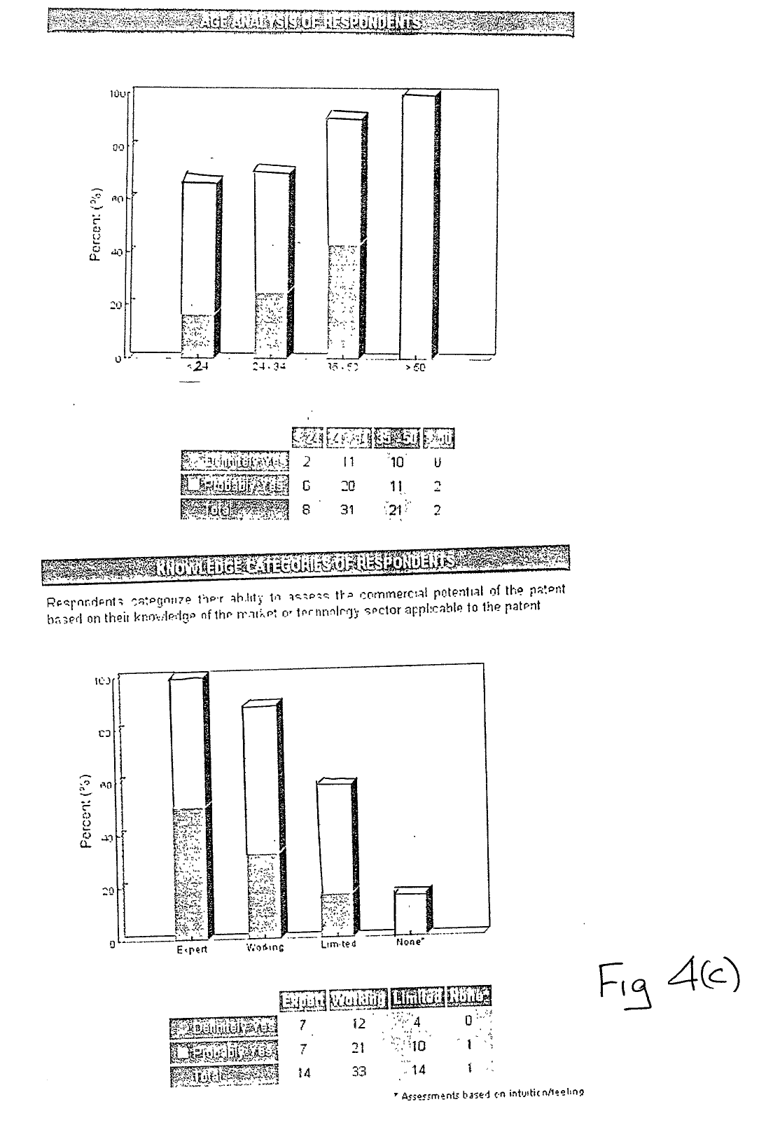

FIG. 4 illustrates in detail a more sophisticated report.

In a first example, there is provided a system for use by patentees who wish to make their invention available to third parties who might enter into commercial arrangements with the patentee. The system is intended for use with persons who may be casually interested in the patents (i.e. persons referred to as “enquirers”) and parties who have a continual interest in a series of patents of any particular grouping (hereinafter called “subscribers”).

The main system comprises a main computer which contains information about the patent. Such information may comprise the number of the patent, the date of issue and the application and or priority date, a copy of the patent specification and drawings, an abridgement, the name and address of the patentee, the name and address of the inventor(s), the international or other classification of the patent. All this information will be substantially constant and will be changed at the main system only on unusual occasions such as when the patentee may change or applications are filed bringing a PCT application into various national or regional phases of prosecution. Thus this information is regarded herein as “fixed information”.

The information contained in the system also includes information acquired as will be described below and which is capable of being continuously altered. This information which is hereinafter called “alterable information”.

As illustrated in FIG. 1, the arrangement operates as follows. When an enquirer using a computer (hereinafter called “the second computer”) accesses the main computer via the Internet with a request about any patent, selected fixed information is provided to the enquirer. At the same time the main computer provides a questionnaire. The enquirer completes the questionnaire which is automatically sent by the second computer back to the main computer. The main computer then automatically updates the alterable information regarding that patent on the basis of the result of the questionnaire so that this information is available on the data base. Additional information which is quite independent of the questionnaire will also be entered and change the alterable information will be for example the fact that a query regarding that patent has been received the time of receipt etc.

The questionnaire, a sample of which is indicated in FIG. 2, will seek typically the following information: the age group of the enquirer, the enquirer's geographic location, the highest level of education of the enquirer, the number of years that the enquirer has experience in the relevant market sector, the level of knowledge of the enquirer and the opinion of enquirer as to the market of commercial potential of the invention of patent. The last question of course gives the most important information of the questionnaire. The question may require answers with different degrees of answers i.e. “definitely yes”, “probably yes”, “probably no” and “definitely no”.

FIG. 3 illustrates how the system provides information to subscribers. As shown, the database is updated continuously. Using the data base, various reports are being generated continuously and in real time. Three typical report formats are provided viz a bar graph, a pie chart and a conventional line graph as desired by the subscriber.

Because of the detail questions raised in the questionnaire, various different reports may be generated as shown in more detail in FIG. 4. This report includes bar graphs based on all the answers to the questions in the questionnaire for persons saying that there is probable or definite viability. In addition it may show (although not illustrated) the number of questionnaires received.

Other reports may compare the experience in the field or highest education with the commercial viability.

Thus if those with experience in the field believe that there is commercial viability and those with little or no such experience believe there is no viability the proprietor and the subscriber can draw certain conclusions. Similarly conclusions may be drawn from the answer to geographic location as against commercial viability—e.g. where the invention relates to snow sports such as ski, the answers as to commercial viability query which come from parties in Switzerland and Austria are likely to be more persuasive than when the answers come from Egypt and the Congo. Similarly for example views on bungee jumping which are provided by persons in excess of say fifty years old are likely to be less persuasive than those of younger persons. Obviously of course most cases will require a much more subtle and sophisticated assessment but the foregoing illustrate dramatically the manner in which assessments can be made.

The patentee can use the report to assist in marketing the patented invention to a potential purchaser or partner. The report can show the attitude of enquirers to the viability of the invention. In addition and importantly the report may indicate the attitude of enquirers in a selected group (as mentioned above) which can be even more specific. Three groups of enquirers may for various inventions or various purchasers have the following characteristics:

| | Group I | Group II | Group II |
|---|---|---|---|
| Level of knowledge of | Expert | Working | Working |
| technology sector | | | |
| Years experience | >10 | 5-10 | 5-10 |
| Geographic Location | USA | Canada | Japan |
| Age Group | 35-50 | 24-34 | <5 |
| Level of Education | Post | High School | Graduate |
| | Graduate | | |

Reports based on the various groups may be generated on line in real time on the basis of the information received from the questionnaires. Indeed the patentee or subscriber may select an analysis from some 1536 reports (or say 256 analyses per country) from the information supplied by the questionnaire.

The invention is not limited to the precise details hereinbefore described. The system may be used with other operations where a input is required as a quid pro quo for other information given so as to enable various parties or indeed various departments within organisations to take decisions based on that input.

Obviously the forms of the questionnaires and demographic information requested thereon can vary. Further the form in which the results are presented may vary in dependence upon the requirements of the various parties. For example instead of the geographic information being given by country it may be given by continent or conversely by state or county.

I claim:

1. Apparatus for providing continuously updated information about an item, the apparatus comprising:
a main computer system including a software system having a data base which contains various information units, being alterable and substantially fixed information units;
first means for accessing selected said information units about a selected item and making said information units available to the second computer operated by an enquirer connecting to the main computer system;
second means for dispatching a questionnaire to the enquirer at said second computer when it is connected to the main computer system to obtain the said selected fixed information units;
receiving means for receiving information received from a complete questionnaire returned by the said second computer and for adding such information to the main data base thereby to alter certain alterable information units; and
means for accessing the alterable information units relating to an item and making this available to a third computer connecting to the main connector system.

2. Apparatus as claimed in claim 1 wherein the main computer system further includes means operable by the operator to change any of fixed data.

3. Apparatus as claimed in claim 1 further including means for causing a prompt signal to emerge at the second computer for prompting the enquirer to complete the questionnaire.

4. A method of providing information to an enquirer requiring said information about an item, the method comprising:
maintaining a data base in a main computer system, which data base comprises fixed and alterable data strings about a number of items,
making selected fixed data strings available to a second computer operated by the enquirer via a computer link and at the same time sending a questionnaire to the enquirer said party at the second computer;
receiving at the main computer system information resulting from completion of the questionnaire and dispatch thereof by the second computer, and
updating the alterable data strings of the said item on the basis of the said the information.

5. A method of providing information about an item to the proprietor having an interest in the latter item, the method comprising:
maintaining a data base in a main computer system, which data base comprises fixed and alterable data strings about a number of items including the said item;
making selected fixed information available to a computer operated by an enquirer via a computer link:
and at the same time in the sending of a questionnaire to the enquirer via said second computer:
receiving at the main computer system information relating resulting from completion of the questionnaire and dispatch thereof by the enquirer through the enquirer's computer:
updating the altered data strings in the main computer system on the basis of the said information resulting from the questionnaire; and
making the information available for access by the proprietor, which said information includes the updated alterable data strings.

6. A method as claimed in claim 4 wherein the system is arranged to process the competed questionnaire in real-time and automatically to generate a report document providing graphs, statistical information and/or explanatory notes.

7. A method as claimed in claim 6 wherein the system is arranged to generate a number of different layouts.

8. A method as claimed in claim 4 wherein the items are patents.
